(19) United States
(12) Patent Application Publication
(10) Pub. No.: US 2015/0224616 A1
(43) Pub. Date: Aug. 13, 2015

(54) MULTI-AXIS MILLING TOOL

(71) Applicant: LABORATOIRES BODYCAD INC., Quebec (CA)

(72) Inventors: Florent Miquel, Quebec (CA); Jean Robichaud, Quebec (CA)

(73) Assignee: LABORATOIRES BODYCAD INC., Quebec, QC (CA)

(21) Appl. No.: 14/409,098

(22) PCT Filed: Jun. 26, 2013
(86) PCT No.: PCT/CA2013/000606

§ 371 Date: Dec. 18, 2014

Related U.S. Application Data
(60) Provisional application No. 61/664,392, filed on Jun. 26, 2012.

(51) Int. Cl. B23Q 1/64; B23C 9/00; B23C 1/00

(52) U.S. Cl. CPC B23Q 1/64; B23C 1/00; B23C 9/00; B23C 2220/32; B23C 2260/04

(57) ABSTRACT

There is provided an apparatus for machining a workpiece having a plurality of faces. The apparatus comprises a machine frame, a cutting tool mounted to the machine frame, a support member, a first connecting member interconnecting the machine frame to the support member and defining a relative rotation between the support member and the machine frame about first and second transverse axes, and a second connecting member engaged to the support member and configured to retain the workpiece, the second connecting member being rotatable with respect to the first connecting member about a third axis for exposing alternate ones of the plurality of faces of the retained workpiece to the cutting tool, the third axis extending along a direction different than respective directions of the first and second axes.

### CROSS-REFERENCE TO RELATED APPLICATIONS

This patent application claims priority of U.S. provisional Application Ser. No. 61/664,392, filed on Jun. 26, 2012.

### TECHNICAL FIELD

The present invention relates to the field of computer-aided machining, in particular to a multi-axis tool for manufacturing prostheses.

### BACKGROUND OF THE ART

In order to reduce costs and increase throughput when machining a workpiece for manufacturing an object having a complex geometry, such as a prosthesis, multi-axis milling machines may be used. Such machines support the workpiece on a frame movable about a plurality of axes. In this manner, the position of the workpiece relative to a cutting tool of the milling machine may be adjusted to improve the machining process. However, such multi-axis machines usually occlude at least one face of the workpiece, this face remaining inaccessible throughout the machining process. Once all faces except the occluded face have been machined, the workpiece then needs to be repositioned to expose the remaining face. This in turn reduces the accuracy and efficiency of the machining process.

There is therefore a need for an improved machining tool for manufacturing objects of complex geometries.

### SUMMARY

In accordance with a first broad aspect, there is provided an apparatus for machining a workpiece having a plurality of faces. The apparatus comprises a machine frame, a cutting tool mounted to the machine frame, a support member, a first connecting member interconnecting the machine frame to the support member and defining a relative rotation between the support member and the machine frame about first and second transverse axes, and a second connecting member engaged to the support member and configured to retain the workpiece, the second connecting member being rotatable with respect to the first connecting member about a third axis for exposing alternate ones of the plurality of faces of the retained workpiece to the cutting tool, the third axis extending along a direction different than respective directions of the first and second axes.

In accordance with a second broad aspect, there is provided a method for machining a workpiece having a plurality of faces using a cutting tool mounted to a machine frame, the method comprising securing the workpiece to a support member interconnected to the machine frame through a first connecting member, the first connecting member defining a relative rotation between the support member and the machine frame about first and second transverse axes, a second connecting member engaged to the support member and retaining the workpiece, the second connecting member rotatable with respect to the first connecting member about a third axis extending along a direction different than respective directions of the first and second axes, exposing alternate ones of the plurality of faces to the cutting tool by at least one of rotating the support member relative to the machine frame about the first axis, rotating the support member relative to the machine frame about the second axis, and rotating the second connecting member relative to the first connecting member about the third axis, and machining the exposed alternate ones of the plurality of faces with the cutting tool.

### BRIEF DESCRIPTION OF THE DRAWINGS

Further features and advantages of the present invention will become apparent from the following detailed description, taken in combination with the appended drawings, in which:

FIG. 1a is a flowchart of a computer-aided method for manufacturing a patient-specific prosthesis, in accordance with an illustrative embodiment of the present invention;

FIG. 1b is a flowchart of the step of virtually machining a 3D model of a prosthesis of FIG. 1a;

FIG. 2 is a front perspective view of a six-axis milling machine, in accordance with an illustrative embodiment of the present invention;

FIG. 3 is a close-up view of the milling machine of FIG. 2;

FIG. 4 is a schematic view of a workpiece, in accordance with an illustrative embodiment of the present invention;

FIG. 5 is a front perspective view of a rotated support frame of a six-axis milling machine, in accordance with an illustrative embodiment of the present invention;

FIG. 6 is a front perspective view of a rotated workpiece support of a six-axis milling machine, in accordance with an illustrative embodiment of the present invention;

FIG. 7a is a front perspective view of a tilted workpiece held in a workpiece support of a six-axis milling machine, in accordance with an illustrative embodiment of the present invention;

FIG. 7b is a front perspective view of a workpiece held in a workpiece support of a six-axis milling machine and rotated at 90 degrees, in accordance with an illustrative embodiment of the present invention;

FIG. 8a is a front perspective view of a cutting tool machining a face of a workpiece held in a six-axis milling machine, in accordance with an illustrative embodiment of the present invention;

FIG. 8b is a front perspective view of the cutting tool machining an alternate face of the workpiece of FIG. 8a with the workpiece held in the rotated support frame of the six-axis milling machine, in accordance with a first illustrative embodiment of the present invention;

FIG. 9a is a front perspective view of a cutting tool machining a face of the workpiece of FIG. 8a with the workpiece held in the rotated support frame of the six-axis milling machine, in accordance with a second illustrative embodiment of the present invention; and

FIG. 9b is a front perspective view of the cutting tool machining an alternate face of the workpiece of FIG. 9a.

It will be noted that throughout the appended drawings, like features are identified by like reference numerals.

### DETAILED DESCRIPTION

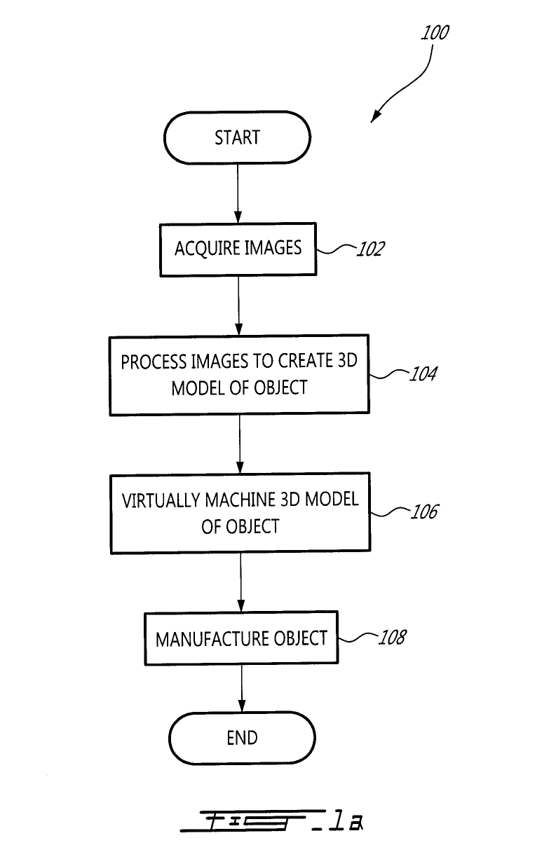

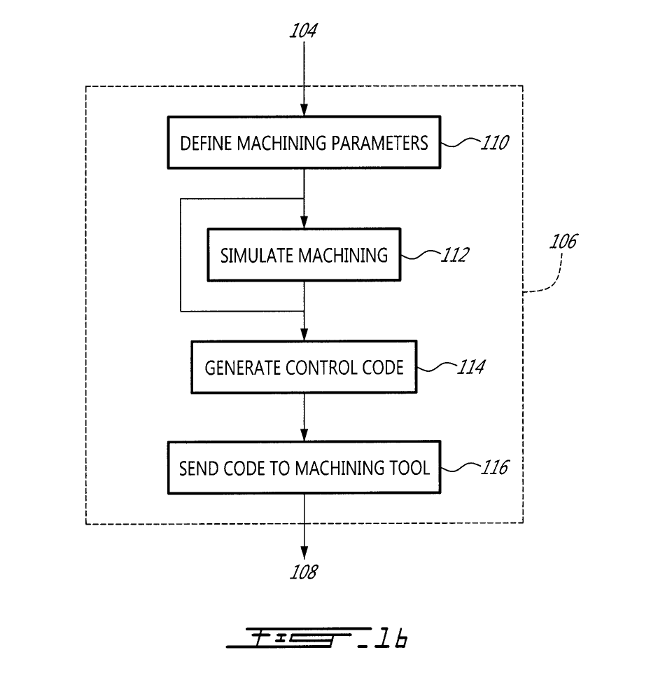

Referring to FIG. 1a, a computer-aided method 100 for manufacturing an object of a complex geometry, such as a patient-specific prosthetic implant will now be described. The method comprises acquiring images at step 102, which refers to acquiring image data related to the object to be manufactured. In the case where a prosthesis is to be manufactured, this comprises capturing images of the patient's anatomical region where the prosthesis is to be implanted. Such anatomical region may for example comprise the hip, knee, and ankle regions when total knee replacement surgery is concerned. It should be understood that other anatomical regions, such as the mouth, ear, hand, etc., may be imaged in the process of manufacturing other types of prosthetic implants. It should also be understood that objects other than prostheses may be manufactured.

The images may be obtained from scans generated using Magnetic Resonance Imaging (MRI), Computed Tomography (CT), ultrasound, x-ray technology, optical coherence tomography, or the like. The images may also be obtained using techniques for three-dimensional scanning of objects, especially when manufacturing objects other than prostheses. Such techniques may include, but are not limited to, white light, laser dot or line projection, time-of-flight, and the like. Acquiring images 102 may be done along one or more planes throughout the body part, such as sagittal, coronal, and transverse. In some embodiments, multiple orientations are performed and the data may be combined or merged during the processing phase (step 104). For example, a base set of images may be prepared on the basis of data acquired along a sagittal plane, with missing information being provided using data acquired along a coronal plane. Other combinations or techniques to optimize the use of data along more than one orientation will be readily understood by those skilled in the art. The captured images may further be provided in various known formats and using various known protocols, such as Digital Imaging and Communications in Medicine (DICOM), for handling, storing, printing, and transmitting information. Other exemplary formats are GE SIGNA Horizon LX, Siemens Magnatom Vision, SMIS MRD/SUR, and GE MR SIGNA 3/5 formats.

Referring to FIG. 1b in addition to FIG. 1a, the images, once captured, are processed (step 104) using a computer software to create a three dimensional (3D) model of the object. In the case of a prosthetic implant, it is desirable for the latter to be adapted to fit the patient's unique anatomical region, e.g. a damaged knee joint, for which the images have been captured. Using such a 3D model, it can be ensured that the prosthetic implant provides adequate integration with surrounding bone. Once the 3D model has been created, it may be virtually machined using the computer software (step 106) prior to manufacturing the object (step 108). In step 106, a user may define machining parameters (step 110), such as the raw workpiece material to be used during the machining process, as well as the cutting tools and cutting operations to be effected. The location of the cutting tool as well as the contact areas between the cutting tool and the workpiece and the inclination, if any, of the cutting tool relative to the surface of the workpiece may further be defined. A specific machining trajectory used for producing an object of the desired shape may therefore be generated. An optional machining simulation may further be performed to enable accurate planning of the machining process (step 112). For instance, step 112 may comprise ascertaining optimum cutting tool positioning relative to the workpiece for providing the fastest access to individual workpiece locations and ensure uniform machining of the desired features of the object. A computer numerical control (CNC) code specifying the tool paths may then be generated by the computer software (step 114). The code may then be sent to the machining tool (step 116) over a suitable communication link for manufacturing the object (step 108) in an automated manner.

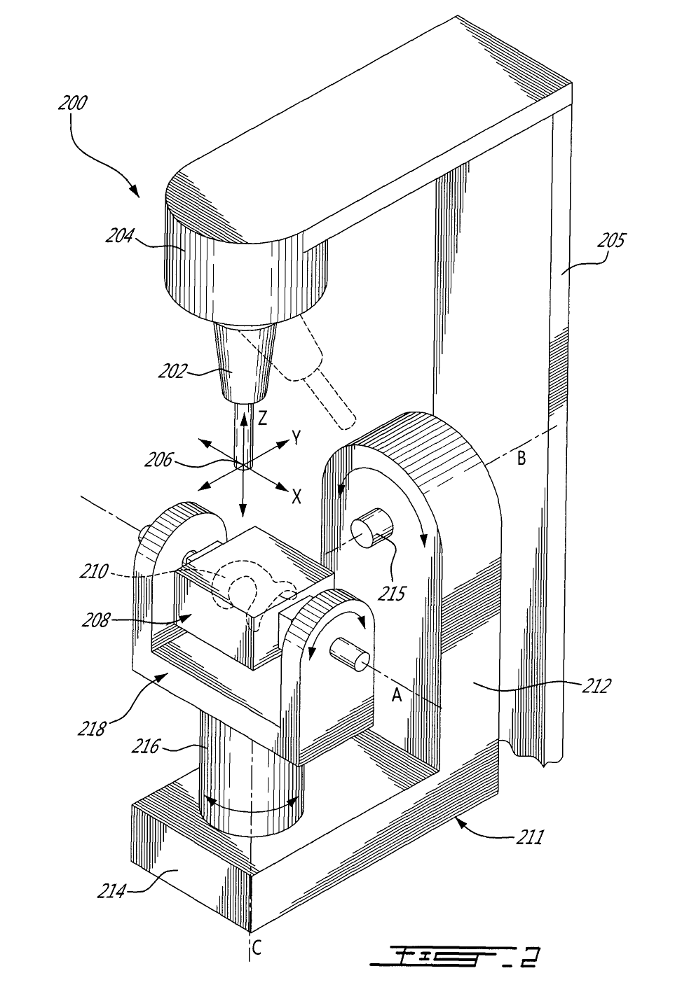

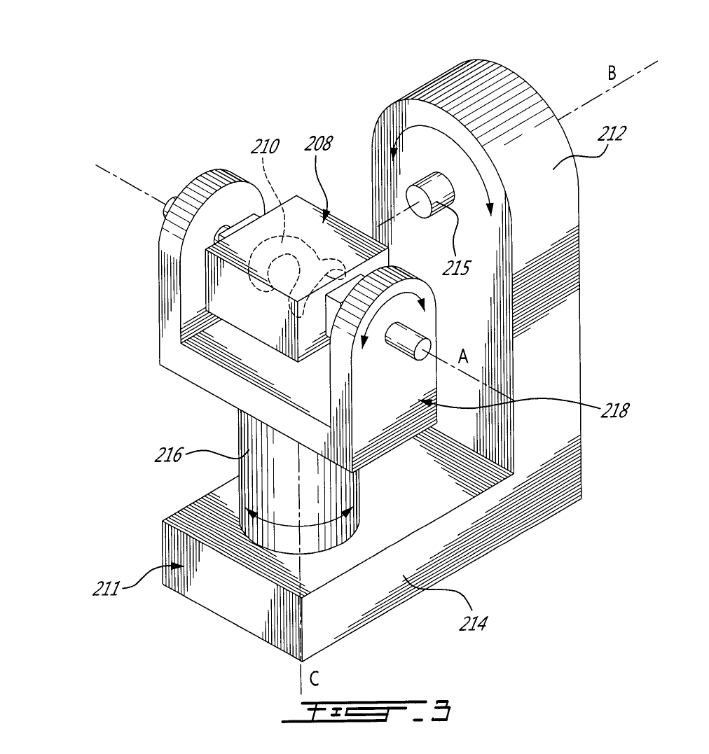

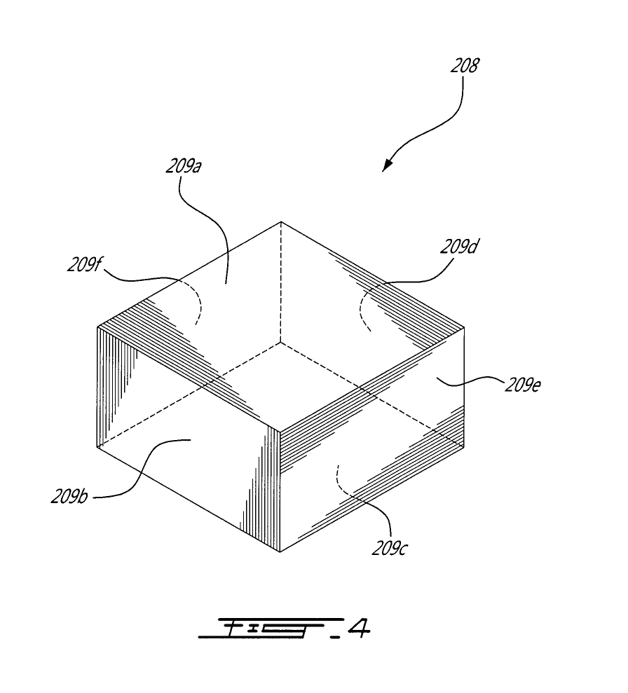

Referring now to FIG. 2, FIG. 3, and FIG. 4, a multi-axis milling machine 200 for free-form machining an object, such as an implant prosthesis, will now be described. The milling machine 200 is illustratively used to implement step 108 of the method 100 described above with reference to FIG. 1a and FIG. 1b. The milling machine 200 illustratively comprises a cutting tool 202 mounted on a connecting member, such as a spindle 204, coupled to a machine frame 205 and having a tip 206 adapted to mate with a surface of a workpiece 208. The workpiece 208, which is illustratively shaped as a block, may be made of any material suitable for manufacturing the object. In the case of a prosthesis, such material may include but not be limited to a polymer, a metal, a cross-linked polymer, a ceramic, a composite, and an alloy.

The cutting tool 202 illustratively has a shape and size adapted to remove material from the workpiece 208 by movement of the tip 206 of the cutting tool 202 within the milling machine 200 and on the surface of the workpiece 208. For this purpose, the cutting tool 202 may be translated along the X, Y, and Z axes using a manual wheel, quill drive, automatic control dial, automatic control from a controller, or the like, to enable accurate positioning of the cutting tip 206 relative to an exposed surface of the workpiece 208. As illustrated in hashed lines on FIG. 2, the spindle 204 may further be angled relative to the Z axis for inclining the cutting tool 202 relative to the exposed surface of the workpiece 208. Illustratively, such a surface may be one of the faces 209a, 209b, 209c, 209d, 209e, and 209f, depending on the orientation of the workpiece 208. Indeed, as will be described below, components of the milling machine 200 may be rotated in three (3) degrees of freedom about axes A, B, and C for positioning the workpiece 208 at a desired orientation relative to the cutting tool 202. In one embodiment, axes B and C are transverse while axis A extends along a direction different than axes B and C. In particular, in the illustrated embodiment, axes A and C and axes B and C are substantially perpendicular. Once the workpiece 208 has been fully machined by the cutting tool 202, a prosthesis 210 having a desired shape may be obtained. Although the workpiece 208 has been illustrated as having the shape of a parallelepiped, it should be understood that any other suitable shape, such as a cylinder, may apply.

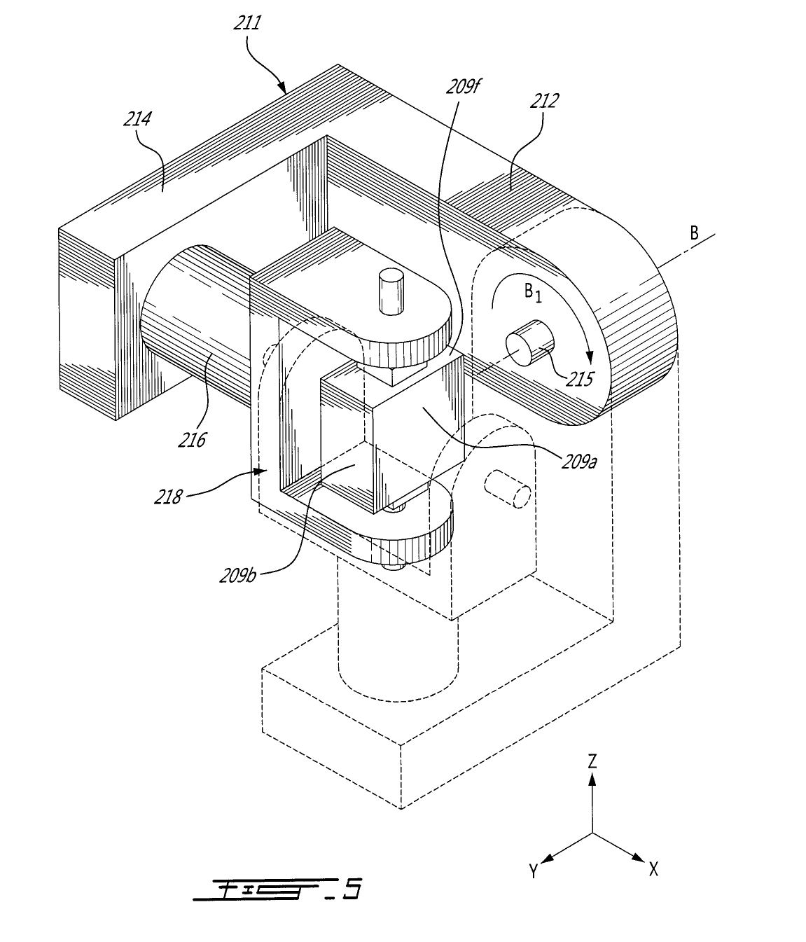

The milling machine 200 further comprises a support frame 211 illustratively comprising a first member, such as a column 212 having a substantially square cross-section, connected to the machine frame 205 and a substantially planar base member 214. The base member 214 illustratively extends away from the column 212 along a plane substantially perpendicular to the plane of the column 212, thereby forming an L-shape therewith. The support frame 211 may be connected to the machine frame 205 through a connection allowing the support frame 211 to be rotatable relative to the machine frame 205 in a clockwise or counterclockwise direction about the rotary axis B. The connection may be a rotary shaft 215 received within an aperture (not shown) formed in the column 212 and extending along axis B for enabling rotation of the support frame 211 about axis B. Any other suitable connection (e.g. a spindle) known to those skilled in the art that allows relative rotation between the support frame 211 and the machine frame 205 about the axis B may apply. As used herein, a direction of rotation is said to be clockwise or counterclockwise when the milling machine 200 is viewed from the front, as shown for example in FIG. 5. The support frame 211 may be rotated in either direction for presenting alternative faces of the workpiece 208 to the cutting tool 202, as will be discussed in further detail below. For example, as illustrated in FIG. 5, the support frame 211 may be rotated in a clockwise direction B1 about axis B from the initial position of FIG. 3, shown in hashed lines, to a rotated position, shown in solid lines.

In order to provide the cutting tool 202 access to the faces (references 209a, 209b, 209c, 209d, 209e, and 209f in FIG. 4) of the workpiece 208, the cutting tool 202 being illustratively positioned above the support frame 211 (see FIG. 2), the support frame 211 may be rotated clockwise or counterclockwise about axis B up to 140 degrees. Given the configuration of the milling machine (reference 200 of FIG. 2), rotation about the axis B beyond 140 degrees may not prove suitable as the presence of the base member 214 would most likely prevent the cutting tool 202 from having access to the workpiece 208. In the example illustrated in FIG. 5, the support frame 211 is rotated clockwise in the direction of arrow B1 by ninety (90) degrees such that the column 212, is rotated from the initial position shown in hashed lines, where the column 212 extends along a substantially vertical plane (not shown), to the rotated position shown in solid lines, where the column 212 extends along a substantially horizontal plane (not shown). It should be understood that the support frame 211 may be rotated by any other suitable angle about the axis B.

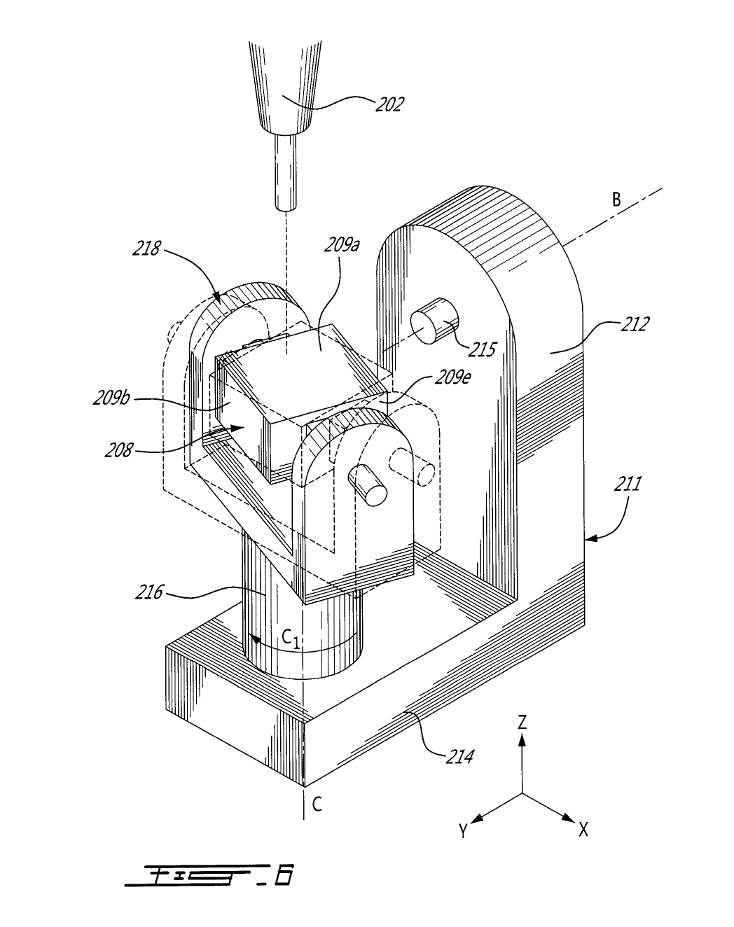

Referring to FIG. 6, a connection, such as a swiveling spindle 216 or the like, is further illustratively mounted to the base member 214 and extends away therefrom along the Z axis. The spindle 216 is adapted to receive and have secured thereto using suitable attachment means, such as fasteners, screw, bolts, and the like, a support member 218 for retaining the workpiece 208. The spindle 216 enables rotation of the support member 218 relative to the machine frame 205 about the rotary axis C with the support frame 211 serving as a connection member interconnecting the machine frame 205 to the support member 218. In this manner, the support member 218 may be rotated clockwise or counterclockwise up to 360 degrees about the rotary axis C. The cutting tool 202 may therefore be provided better access to a surface, as in 209a, of the workpiece 208 held on the workpiece support member 218 and presented to the cutting tool 202 at a suitable orientation. As a result, the cutting tool 202 can more efficiently machine the surface as in 209a. It should be understood that, in other embodiments, angles beyond 360 degrees may apply. Indeed, the support member 218 may be caused to rotate (either clockwise or counterclockwise) by more than one turn, for instance by one full turn (360 degrees) and an additional angle, e.g. forty (40) degrees for a total of 400 degrees. Other angles may apply.

For example, the workpiece support member 218, and accordingly the workpiece 208 held thereon, may be rotated in a counterclockwise direction C1 about the axis C. As a result, the workpiece support member 218 is moved from the initial position shown in hashed lines, to a rotated position, shown in solid lines. In the rotated position, a longitudinal axis (not shown) of the workpiece support member 218 is at a more acute angle relative to the axis B than was the case in the initial position. By rotating the workpiece support member 218 further counterclockwise in the direction of arrow C1, the side face 209b of the workpiece 208 may be made more accessible to the cutting tool 202. The cutting tool 202 may then access the side face 209b by angling the spindle (reference 204 in FIG. 2) relative to the Z axis, thereby inclining the cutting tool 202 so that the latter is positioned in proximity to the side face 209b. Alternatively, the side face 209b may be made even more accessible to the cutting tool 202 by rotating the support frame 211 clockwise about axis B.

Although the base member 214 has been illustrated as substantially planar and a column 212 is shown for illustrative purposes, thus resulting in a support frame 211 having an L-shape, it should be understood that the base member 214 and column 212 may have any other shape suitable for supporting the swiveling spindle 216 and accordingly the workpiece support member 218 thereon. For example, the support frame 211 may only comprise the base member 214, and accordingly need not have an L-shape. Also, the base member 214 may have a curved surface. A pair of columns as in 212 may also be provided on opposite edges (not shown) of the base member 214, thus forming a U-shaped support frame 211. In addition, instead of the spindle 216, shaft 215, and support frame 211, a rotating swivel head (not shown) may couple the workpiece support member 218 to the machine frame (reference 205 in FIG. 2) for enabling rotation thereof about the B and C axes of FIG. 3. Other configurations will be readily understood by those skilled in the art.

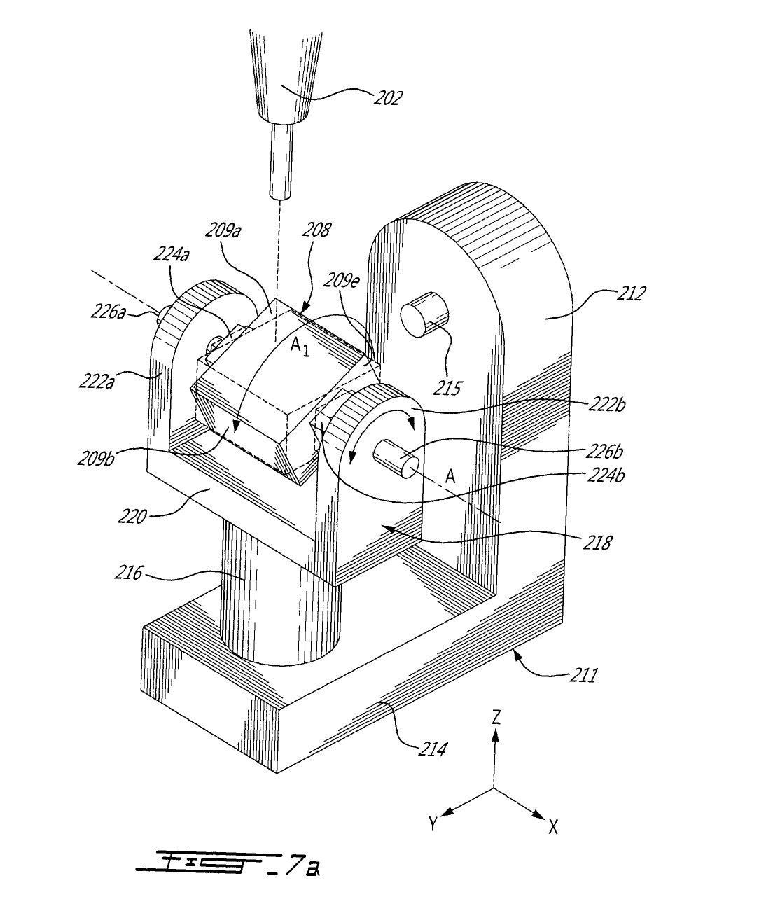

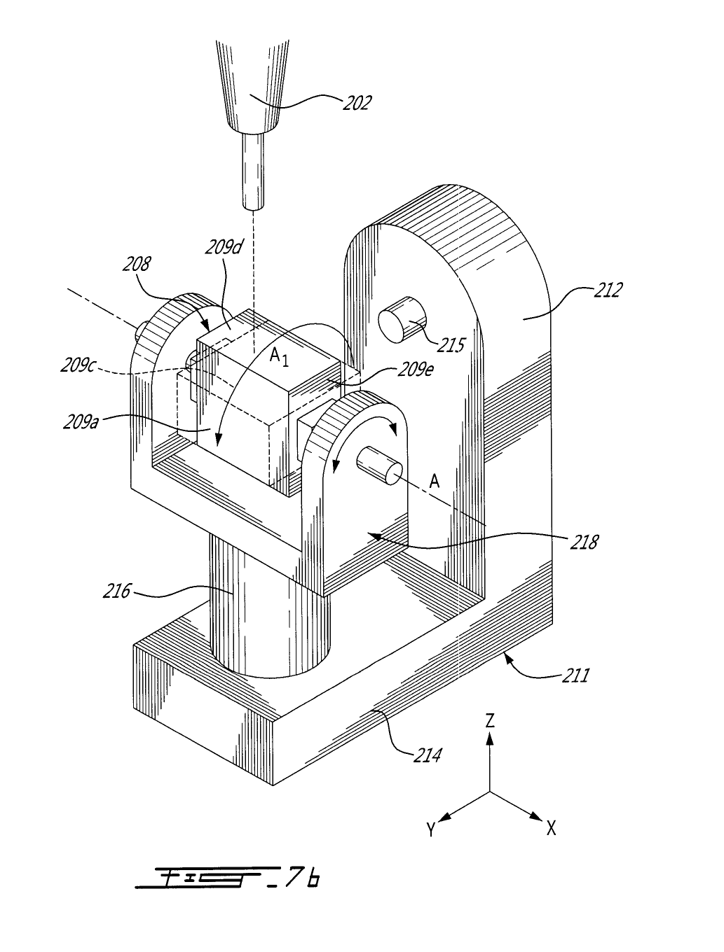

Referring to FIG. 7a, the workpiece support member 218 illustratively comprises a first substantially planar base member 220 extending along a plane substantially parallel to the plane of the base member 214. A pair of arms 222a and 222b project upwardly from opposite edges (not shown) of the base member 220. Each arm 222a, 222b extends along a plane substantially perpendicular to the plane of the base member 220, thereby resulting in a U-shaped workpiece support member 218. A pair of support plates 224a and 224b may further be positioned adjacent the arms 222a and 222b and secured thereto using a suitable connection or attachment means, as will be discussed below. The support plates 224a, 224b are illustratively adapted to engage opposite faces, as in 209e and 209f (see FIG. 4), of the workpiece 208 for securely retaining the workpiece 208 between the support plates 224a and 224b. The support plates 224a and 224b are illustratively shaped and sized so as to contact a reduced area of the opposite faces 209e and 209f of the workpiece 208. In this manner, the cutting tool 202 may still be provided access to a portion of the faces 209e and 209f for machining thereof while the faces 209a, 209f remain in contact with the support plates 224a, 224b. In particular, it is desirable for the support plates 224a, 224b to contact as little of the faces 209e, 209f as possible so that only a reduced portion thereof may still remain once the machined workpiece 208 is produced by the machining tool 200. The machined workpiece 208 would then be reworked in a subsequent machining process to remove any unwanted remaining material. For analogous reasons, it is desirable for the arms 222a and 222b to have as small a width as possible, thereby occluding as little as possible of the faces of the workpiece 208, e.g. faces 209e, 209f, they are adjacent to.

In one embodiment, an attachment means comprising a first and a second rotary shaft 226a, 226b is used to secure each support plate 224a, 224b to a corresponding arm 22a, 222b. In particular, the first rotary shaft 226a may be received in apertures (not shown) formed in the arm 222a and the support plate 224a for rotatably coupling the arm 222a to the support plate 224a. Similarly, the second rotary shaft 226b may be received in apertures (not shown) formed in the arm 222b and the support plate 224b for rotatably coupling the arm 222b to the support plate 224b. When in place, the shafts 226a and 226b illustratively extend along the X axis and may be rotated up to 360 degrees about the rotary axis A in either a clockwise or a counterclockwise direction. In this manner, respective rotation of the support plates 224a and 224b about the axis A relative to the arms 222a and 222b can be achieved. It should be understood that it is desirable for shafts 226a, 226b to be rotated simultaneously in the same direction and by the same angle in order to achieve suitable rotation of the workpiece 208 retained within the support plates 224a, 224b. It should also be understood that the workpiece 208 may be support by the support member 218 and allowed to rotate relative thereto about axis A using any suitable means other than the support plates 224a, 224b. Moreover, it should be understood that the shafts 226a and 226b may be rotated beyond 360 degrees so as to rotate by more than one full turn. For example, as discussed above, the shafts 226a and 226b may be rotated by 400 degrees. Any other angle may apply. In particular, the angles of rotation of the shafts 226a and 226b may be unlimited. In this case, the shafts 226a, 226b may be provided with infinite rotation angles (in either the clockwise or counterclockwise directions) so as to continuously rotate while the workpiece 208 is being machined.

It should further be understood that, although illustrated and described as having a U-shape, the workpiece support member 218 may have any other shape suitable for rotatably supporting the workpiece 208. For example, although the arms 222a and 222b are illustrated as being substantially perpendicular to the base member 220, the arms 222a, 222b may be projecting upwards therefrom at an angle other than ninety (90) degrees so long as rotary movement of the workpiece 208 relative to the axis A as well as rotary movement of the workpiece support member 218 about the axis C are enabled. Other configurations known to those skilled in the art may apply.

Provision of the rotary shafts 226a, 226b allows for the workpiece 208 retained between the support plates 224a and 224b to be rotated about the axis A for exposing alternate adjacent faces 209a, 209b, 209c, and 209d of the workpiece 208. The workpiece 208 may further be tilted about the axis A, to adjust the inclination of an exposed surface, as in 209a, relative to the Z axis. In this manner, the exposed surface as in 209a may be inclined to facilitate the machining process. It should be understood that the cutting tool 202 may also be angled relative the Z axis and accordingly relative to an exposed surface, as in 209a, of the workpiece 208 by inclining the spindle 204, as discussed above.

For example, as illustrated in FIG. 7a, the workpiece 208 may be rotated in a counterclockwise direction A1 about the axis A from an initial position, shown in hashed lines, to a tilted position, shown in solid lines. In the illustrated position, a plane of the upper face 209a of the workpiece 208 is at a more acute angle relative to the Z axis than was the case in the initial position. This may ease the machining process. As illustrated in FIG. 7b, by rotating the workpiece 208 further in the counterclockwise direction A1, e.g. at ninety (90) degrees relative to the initial position shown in hashed lines, the side face 209d of the workpiece 208 may be made more accessible to the cutting tool 202. Rotating the workpiece 208 further in the counterclockwise direction A1, e.g. by 180 degrees relative to the initial position, enables exposure of the bottom face 209c of the workpiece 208 (shown in hashed lines), which would otherwise not be accessible to the cutting tool 202 even if the latter was to be angled about the Z axis.

A robot (not shown), such as a CNC-type machine or a multi-axis robot with articulated arms, may be used to induce rotation of the milling machine 200 about at least one of the axes A, B, and C, and thereby induce rotation of the workpiece 208 relative to the cutting tool 202. In this manner, access to all six faces 209a, 209b, 209c, 209d, 209e, and 209f of the workpiece 208 may be provided for machining thereof. As a result, more uniform machining accuracy may be achieved, as desired for producing high precision objects with complex geometries, such as the prosthesis 210 shown in FIG. 2. As discussed above, it will be apparent that objects other than the prosthesis 210 may be machined using the milling machine 200. As also discussed, it should also be understood that the A, B, and C axes may be rotated clockwise, counterclockwise, or both.

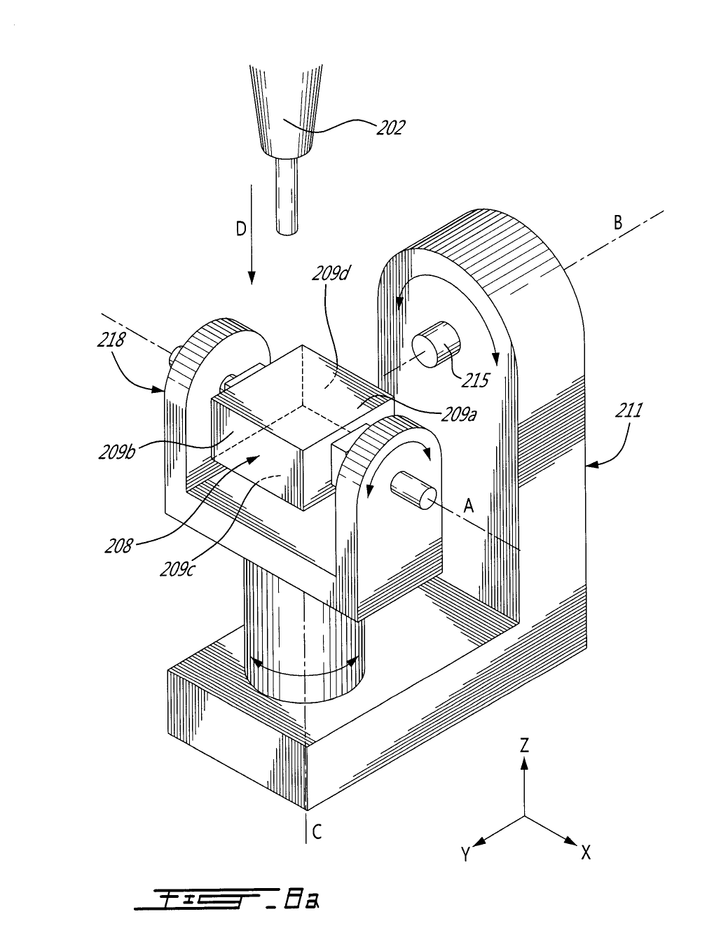

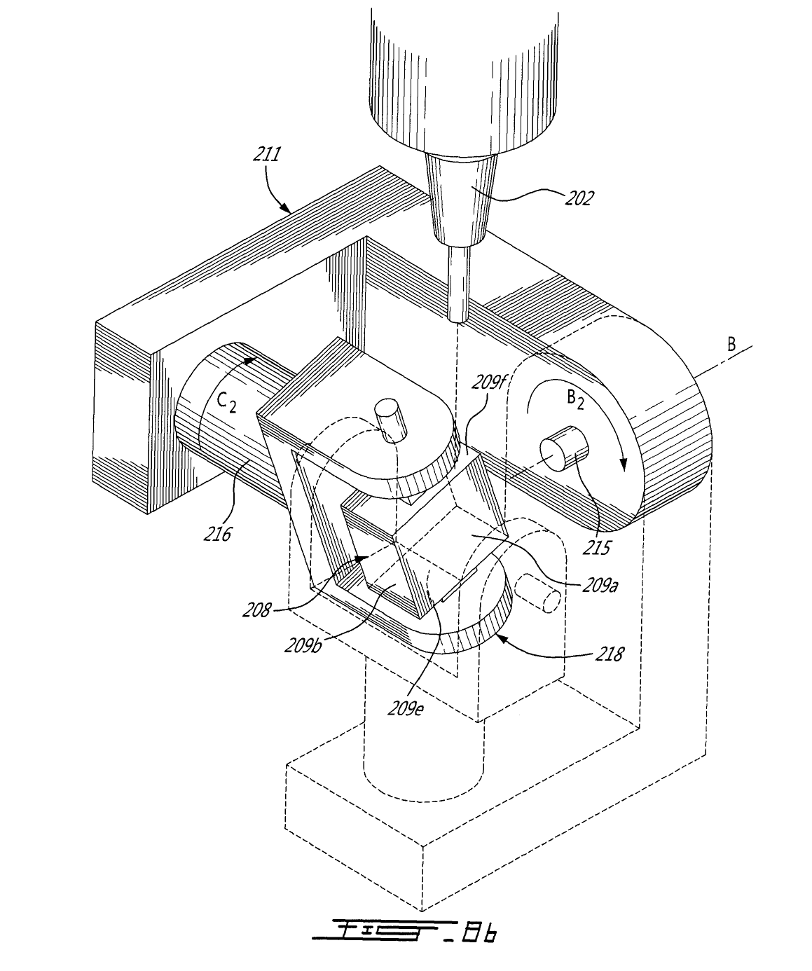

For example, referring to FIG. 8a, during the machining process, the cutting tool 202 may be translated about the Z axis in the direction of arrow D towards the workpiece 208 for machining the top face 209a. The workpiece 208 may then be rotated up to 180 degrees about the axis A for alternatively exposing the side face 209b, the bottom face 209c, and the side face 209d of the workpiece 208 to the cutting tip 206. As shown in FIG. 8b, the support frame 211 may then be rotated clockwise by ninety (90) degrees about the axis B in the direction of arrow B2 so as to be displaced from the initial position shown in hashed lines toward the rotated position shown in solid lines. In this manner, the side face 209f of the workpiece 208 can be exposed to the cutting tool 202. Rotation about axis B by more than ninety (90) degrees is also possible, such as 140 degrees. Rotation by less than ninety (90) degrees is also possible. Using the spindle 216, the workpiece support member 218 may then be rotated counterclockwise by 180 degrees about the axis C in the direction of arrow C2. In this manner, the side face 209e of the workpiece 208 can be presented to the cutting tip 206 for machining thereof and all six faces 209a, 209b, 209c, 209d, 209e, and 209f of the workpiece 208 may be machined. As discussed above, in order to access the faces 209e and 209f once the faces 209a, 209b, 209c, and 209d have been machined, rather than rotating the support frame 211 in the direction of arrow B2 and the workpiece support member 218 in the direction of arrow C2 to achieve the position illustrated in FIG. 8b, the cutting tool 202 may be translated about the X and Y axes as well as angled relative the Z axis to gain proper access to the faces 209e and 209f while the support frame 211 and workpiece support member 218 remain in the position illustrated in FIG. 8a.

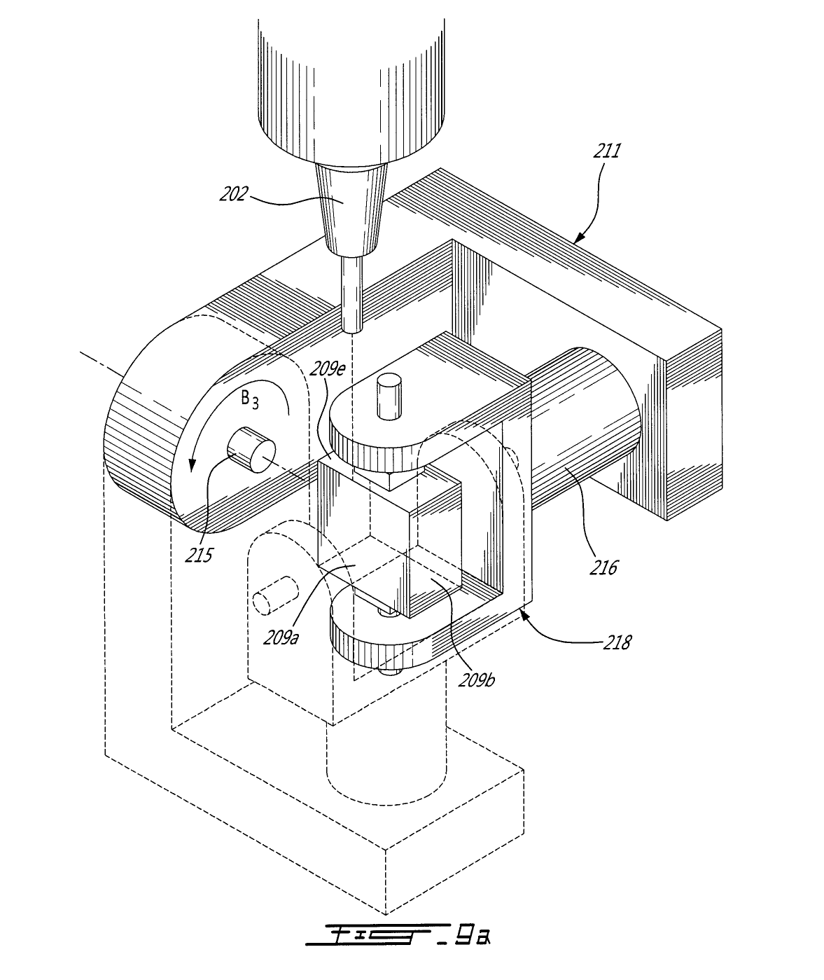

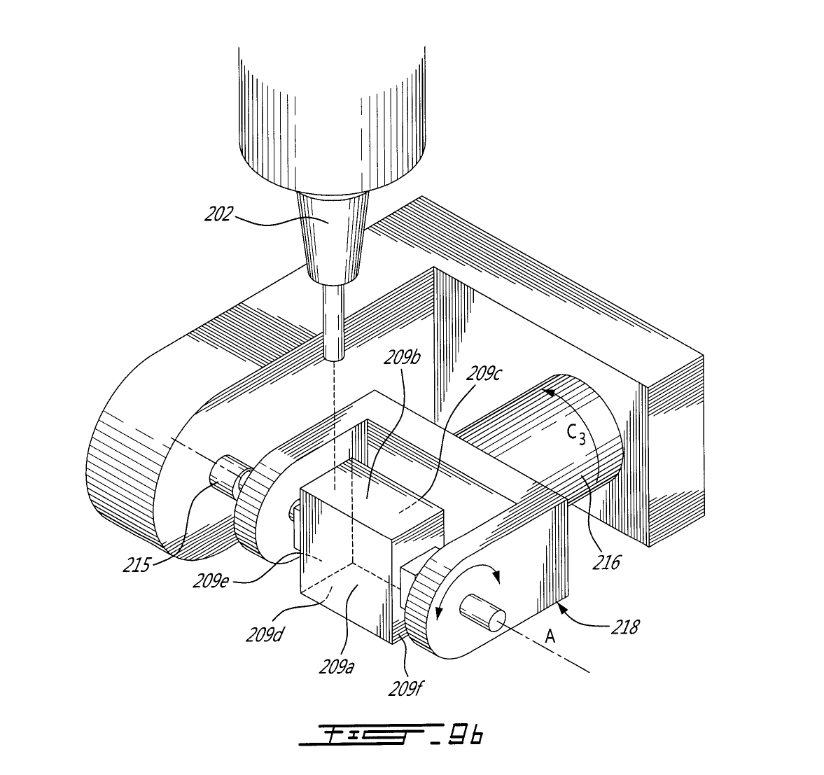

Referring now to FIG. 9a and FIG. 9b, the faces 209a, 209b, 209c, 209d, 209e, and 209f of the workpiece 208 may also be machined using a set of positions of the support frame 211 and workpiece support member 218 alternate to the positions described above with reference to FIG. 8a and FIG. 8b. As shown in FIG. 9a, the support frame 211 may first be rotated counterclockwise by ninety (90) degrees about the axis B in the direction of arrow B3 so as to be displaced from the initial position shown in hashed lines toward the rotated position shown in solid lines. In this manner, side face 209e can be exposed to the cutting tool 202. Using the spindle 216, the workpiece support member 218 may then be rotated counterclockwise by ninety (90) degrees about the axis C in the direction of arrow C3 (see FIG. 9b) for exposing face 209b to the cutting tool 202. It should be understood that angles other than ninety (90) degrees may apply. Further rotation of the workpiece support member 218 counterclockwise in the direction of arrow C3 may enable alternate exposure of faces 209f and 209d to the cutting tool 202. Upon rotation of the workpiece 208 about the axis A, faces 209a and 209c may then be suitably positioned relative to the cutting tool 202 so as to be accessed thereby.

Rotation of the workpiece 208 along at least one of the A, B, and C axes therefore enables positioning of the tip (reference 206 in FIG. 2) of the cutting tool 202 at specific angles and/or locations relative to exposed surfaces of the workpiece 208. In one embodiment, rotation about axis A may be performed over 360 degrees, rotation about axis B may be performed between +/−140 degrees, and rotation about axis C may be performed over 360 degrees. Variants of the range of rotation will be readily understood by those skilled in the art. It will also be understood that various sets of positions of the support frame 211 and workpiece support member 218 may be used to enable machining of all faces (references 209a, 209b, 209c, 209d, 209e, and 209f in FIG. 4) of the workpiece 208.

In addition, as discussed above, translation of the cutting tool 202 about the X, Y, and Z axes illustratively enables the cutting tool 202 to more accurately remove material from the workpiece 208. Use of the six-axis milling machine 200 may further reduce the total machining cost by reducing the volumes of machines, tooling, and fixturing that would be needed to achieve the same result. This in turn eliminates separate setups and reduces queue times, leading to an increased throughput and time savings. Completion of the machining process in a single setup also reduces scrap, rework, and part handling.

It should be noted that the embodiments of the invention described above are intended to be exemplary only. The scope of the invention is therefore intended to be limited solely by the scope of the appended claims.

1. An apparatus for machining a workpiece having a plurality of faces, the apparatus comprising:
a machine frame;
a cutting tool mounted to the machine frame;
a support member;
a first connecting member interconnecting the machine frame to the support member and defining a relative rotation between the support member and the machine frame about first and second transverse axes; and
a second connecting member engaged to the support member and configured to retain the workpiece, the second connecting member being rotatable with respect to the first connecting member about a third axis for exposing alternate ones of the plurality of faces of the retained workpiece to the cutting tool, the third axis extending along a direction different than respective directions of the first and second axes.

2. The apparatus of claim 1, wherein the first connecting member is connected to the machine frame through a first connection allowing rotation of the first connecting member relative to the machine frame about the first axis and is connected to the support member through a second connection allowing rotation of the support member relative to the machine frame about the second axis, the first and second connections spaced apart from one another.

3. The apparatus of claim 2, wherein the first connecting member comprises a first member extending along a first plane and a second member extending along a second plane substantially perpendicular to the first plane, the first connection connecting the first member to the machine frame and the second connection connecting the second member to the support member.

4. The apparatus of claim 1, wherein the support member comprises a base member extending along a third plane, a first side member, and a second side member, the first and second side members extending away from opposite edges of the base member in a same direction and along a fourth plane substantially perpendicular to the third plane.

5. The apparatus of claim 4, wherein the second connecting member comprises a first support plate and a second support plate, the first support plate connected to the first side member through a third connection allowing rotation of the first support plate relative to the first side member about the third axis and the second support plate connected to the second side member through a fourth connection allowing rotation of the second support plate relative to the second side member about the third axis.

6. The apparatus of claim 5, wherein the first support plate is adapted to engage a first one of the plurality of faces at a first contact area and the second support plate is adapted to engage a second one of the plurality of faces opposite the first face at a second contact area, thereby retaining the workpiece between the first and second support plates, the first contact area reduced relative to a first area of the first face and the second contact area reduced relative to a second area of the second face.

7. The apparatus of claim 1, wherein the support member is rotatable relative to the machine frame one of clockwise and counterclockwise about at least one of the first axis and the second axis and further wherein the second connecting member is rotatable with respect to the first connecting member one of clockwise and counterclockwise about the third axis.

8. The apparatus of claim 1, wherein the support member is rotatable about the first axis by a first angle lower than or equal to 140 degrees.

9. The apparatus of claim 1, wherein the support member is rotatable relative to the machine frame about the first axis substantially perpendicular to the second axis and the second connecting member is rotatable with respect to the first connecting member about the third axis substantially perpendicular to the second axis.

10. A method for machining a workpiece having a plurality of faces using a cutting tool mounted to a machine frame, the method comprising:
securing the workpiece to a support member interconnected to the machine frame through a first connecting member, the first connecting member defining a relative rotation between the support member and the machine frame about first and second transverse axes, a second connecting member engaged to the support member and retaining the workpiece, the second connecting member rotatable with respect to the first connecting member about a third axis extending along a direction different than respective directions of the first and second axes;
exposing alternate ones of the plurality of faces to the cutting tool by at least one of rotating the support member relative to the machine frame about the first axis, rotating the support member relative to the machine frame about the second axis, and rotating the second connecting member relative to the first connecting member about the third axis; and
machining the exposed alternate ones of the plurality of faces with the cutting tool.

11. The method of claim 10, wherein rotating the support member relative to the machine frame about the first axis comprises rotating the first connecting member relative to the machine frame about the first axis through a first connection connecting the first connecting member to the machine frame.

12. The method of claim 11, wherein rotating the support member relative to the machine frame about the second axis comprises rotating the support member relative to the machine frame about the second axis through a second connection connecting the first connecting member to the support member.

13. The method of claim 10, wherein rotating the support member relative to the machine frame about the first axis comprises rotating the support member one of clockwise and counterclockwise about the first axis by a first angle lower than or equal to 140 degrees.

14. The method of claim 10, wherein rotating the support member relative to the machine frame about the second axis comprises rotating the support member one of clockwise and counterclockwise about the second axis by a second angle.

15. The method of claim 10, wherein rotating the support member about the second axis comprises rotating the support member about the second axis substantially perpendicular to the first axis.

16. The method of claim 10, wherein securing the workpiece to the support member comprises engaging a first one of the plurality of faces with a first support plate and engaging a second one of the plurality of faces with a second support plate, the second face opposite the first face, the first support plate connected to a first side member the support member through a third connection allowing rotation of the first support plate relative to the first side member about the third axis and the second support plate connected to a second side member of the support member through a fourth connection allowing rotation of the second support plate relative to the second side member about the third axis.

17. The method of claim 16, wherein securing the workpiece to the support member comprises engaging the first face at a first contact area and engaging the second face at a second contact area, the first contact area reduced relative to a first area of the first face and the second contact area reduced relative to a second area of the second face.

18. The method of claim 16, wherein rotating the second connecting member relative to the first connecting member about the third axis comprises simultaneously rotating the first and second support plates one of clockwise and counterclockwise about the third axis by a third angle.

19. The method of claim 10, wherein rotating the second connecting member about the third axis comprises rotating the second connecting member about the third axis substantially perpendicular to the second axis.
